(19) United States
(12) Patent Application Publication
(10) Pub. No.: US 2026/0160323 A1
(43) Pub. Date: Jun. 11, 2026

(54) PLANETARY GEAR

(71) Applicant: WITTENSTEIN SE, Igersheim (DE)

(72) Inventors: Stefan Bruder, Creglingen (DE); Marco Heckmann, Boxberg (DE); Katharina Heller, Tauberrettersheim (DE); Michael Lesch, Giebelstadt (DE); Daniel Sattler, Weikersheim (DE)

(73) Assignee: WITTENSTEIN SE, Igersheim (DE)

(21) Appl. No.: 19/408,761

(22) Filed: Dec. 4, 2025

(30) Foreign Application Priority Data
Dec. 6, 2024 (DE) 102024136508.0

(51) Int. Cl. F16H 57/023; B23K 11/00; B23K 101/00; F16H 1/28

(52) U.S. Cl. CPC F16H 57/023; B23K 11/002; F16H 1/28; B23K 2101/008

(57) ABSTRACT

Planetary transmission having transmission-housing elements, wherein at least one of the transmission-housing elements has an internal toothing which is oriented toward an axis of rotation of the planetary transmission, the transmission-housing elements have in each case at least one joining region, the joining regions have in each case one connecting surface, which is formed at least substantially perpendicularly to the axis of rotation and in a manner running around the axis of rotation, and one stop surface, which is spaced apart axially from the connecting surface and is formed at least substantially perpendicularly to the axis of rotation and in a manner running around the axis of rotation, and wherein the connecting surface of the first transmission-housing element is welded to the connecting surface of the second transmission-housing element.

### BACKGROUND OF THE INVENTION

The disclosure relates to a planetary transmission having transmission-housing elements.

### PRIOR ART

Planetary transmissions having screw-connected interfaces between transmission-housing elements are known from the prior art.

Furthermore, welded or adhesively bonded interfaces between components of a planetary transmission are known from the prior art.

However, the state of the art has disadvantages concerning expenditure in terms of work, production, costs or strength.

### SUMMARY OF THE INVENTION

It is an object of the invention to specify a planetary transmission that is improved in relation to the prior art. In particular, the intention is to specify a planetary transmission of modular construction that allows a modular assembly and connection of different transmission-housing elements.

The object is achieved by way of a planetary transmission as disclosed herein, and by way of a method for connecting a first transmission-housing element of a planetary transmission and a second transmission-housing element of the planetary transmission also as disclosed herein.

A first aspect relates to a planetary transmission having transmission-housing elements, wherein at least one of the transmission-housing elements has an internal toothing which is oriented toward an axis of rotation of the planetary transmission, the transmission-housing elements have in each case at least one joining region, the joining regions have in each case one connecting surface, which is oriented at least substantially perpendicularly to the axis of rotation and in a manner running around the axis of rotation, and one stop surface, which is spaced apart axially from the connecting surface and is oriented at least substantially perpendicularly to the axis of rotation and in a manner running around the axis of rotation, and wherein the connecting surface of the first transmission-housing element is welded to the connecting surface of the second transmission-housing element.

A further aspect relates to a method for connecting a first transmission-housing element of a planetary transmission and a second transmission-housing element of the planetary transmission, wherein the first transmission-housing element has an internal toothing oriented toward an axis of rotation of the planetary transmission and has a first joining region, and the second transmission-housing element has a second joining region, wherein the joining regions are of stepped form, and wherein the first joining region and/or the second joining region have welding projections. The method comprises aligning the first transmission-housing element and the second transmission-housing element with one another so that the first joining region and the second joining region engage one into the other; and welding the first joining region of the first transmission-housing element to the second joining region of the second transmission-housing element by means of a resistance welding process.

A further aspect relates to a planetary transmission having a first transmission-housing element and a second transmission-housing element which are connected using one of the typical methods described herein.

Where below an enumeration contains “or”, this means “and/or”, unless specified otherwise.

In typical embodiments, the planetary transmission comprises at least 2, at least 3, at least 4, at least 5 or at least 8 transmission-housing elements. At least one of the transmission-housing elements has an internal toothing which is oriented toward an axis of rotation of the planetary transmission. Typically, the planetary transmission has one, two or three transmission-housing elements with in each case one internal toothing which is oriented toward the axis of rotation of the planetary transmission. Typically, a number of transmission-housing elements with in each case one internal toothing oriented toward the axis of rotation of the planetary transmission corresponds to a number of transmission stages of the planetary transmission. By way of example, a two-stage planetary transmission has two transmission-housing elements with in each case one internal toothing oriented toward the axis of rotation of the planetary transmission. Typical planetary transmissions have one, two or three transmission stages. Typically, the internal toothing of the at least one transmission-housing element engages into planet gears of the planetary transmission. In typical embodiments, the at least one transmission-housing element with internal toothing has a wall thickness of at least 5%, at least 10%, or at least 15%, of an outer radius of the transmission-housing element. In typical embodiments, the at least one transmission-housing element with internal toothing has a wall thickness of at most 20%, at most 25%, or at most 30%, of an outer radius of the transmission-housing element. Preferably, the at least one transmission-housing element with internal toothing has a wall thickness of at least 10% and at most 25%. This can advantageously allow small outer diameters of the transmission housing, and thus of the planetary transmission. Typically, the transmission-housing elements are designed as a hollow shaft. Typically, the transmission-housing elements have an equal outer diameter, in particular the transmission-housing elements are arranged so as to be flush with one another at their outer contour.

In typical embodiments, the transmission-housing elements comprise a drive flange, a bearing flange or an adapter plate. In embodiments, the drive flange and the adapter plate are designed as a single part, in particular as an adapter flange. An adapter plate which is designed as a transmission-housing element according to one of the embodiments described herein can advantageously make possible an individualized or variable adapter plate for connection of the planetary transmission to a motor, with further transmission-housing elements being able to remain standardized. In embodiments, the adapter plate is a universal adapter plate. In embodiments, the adapter plate is not welded to the transmission-housing elements, but is in particular screwed thereto. Typically, a hole circle for screw connection of the adapter plate, in particular a motor adapter plate, is independent of the arrangement of the transmission-housing elements. In particular, the welding of the transmission-housing elements advantageously allows the hole circle for screw connection of the adapter plate to be decoupled from the connection of the transmission-housing elements.

In typical embodiments, the transmission-housing elements are manufactured from a metal. In particular, the metal encompasses non-alloy steels, alloy steels, by way of example stainless high-grade steels, cast materials or powder metals. Typically, the transmission-housing elements, and in particular the transmission-housing elements with an internal toothing oriented toward the axis of rotation of the planetary transmission, are produced by cutting or primary forming, in particular by additive manufacturing or powder metallurgy, or by deformation, for example by cold extrusion.

The transmission-housing elements have at least one joining region. Typically, the transmission-housing elements have at most two joining regions. In particular, the transmission-housing elements have one or two joining regions, wherein, in typical embodiments, the planetary transmission has both transmission-housing elements with one joining region and transmission-housing elements with two joining regions. In particular, in typical embodiments, two transmission-housing elements have in each case one joining region and the further transmission-housing elements have in each case two joining regions.

Typically, joining regions of the transmission-housing elements are spaced apart from one another along the axis of rotation of the planetary transmission. In particular, one of the joining regions is arranged on a side of the transmission-housing element that faces toward the drive and a further joining region is arranged on a side of the transmission-housing element that faces toward the output.

Typically, the at least one transmission-housing element with the internal toothing has two joining regions. In particular, the at least one transmission-housing element with the internal toothing has in each case one joining region arranged on a side of the transmission-housing element facing toward the drive and has a further joining region arranged on a side of the transmission-housing element that faces toward the output.

The joining regions have in each case one connecting surface, which is formed at least substantially perpendicularly to the axis of rotation and in a manner running around the axis of rotation, and one stop surface, which is spaced apart axially from the connecting surface and is formed at least substantially perpendicularly to the axis of rotation and in a manner running around the axis of rotation. The expression “at least substantially perpendicularly” typically encompasses herein deviations from the perpendicular plane of up to 10° or up to 30° or up to 45°. Typically, the expression “at least substantially perpendicularly” may encompass also a perpendicular orientation or exclusively a perpendicular orientation.

The connecting surface and the stop surface are typically formed in such a way that a joining region of a first of the transmission-housing elements and a joining region of a further transmission-housing element engage one into the other. In particular, the joining regions are typically of stepped form.

In typical embodiments, the connecting surface and the stop surface are substantially parallel. Typically, the connecting surface and the stop surface do not intersect.

In typical embodiments, the stop surfaces of welded transmission-housing elements abut against one another. In particular, the stop surfaces are not joined, in particular are not welded, to one another. The stop surfaces advantageously define the position, in particular along the axis of rotation of the planetary transmission, of the transmission-housing elements in the planetary transmission. The transmission-housing elements can be displaced, in particular positioned or centered, typically along the stop surfaces or parallel to the stop surfaces, perpendicularly to the axis of rotation of the planetary transmission before welding of the connecting surfaces.

In typical embodiments, the welded connecting surfaces are arranged radially within the respective stop surfaces. In embodiments, the welded connecting surfaces are arranged radially outside the respective stop surfaces. In particular, the welded connecting surfaces and the respective stop surfaces substantially do not overlap in a radial direction. In particular, the welded connecting surfaces and the respective stop surfaces overlap in the radial direction by at most 5% or at most 10% of the respective radial extent.

Typically, a weld seam for connecting the first connecting surface to the second connecting surface is arranged in the interior of a contour of the planetary transmission, and in particular in the interior of a contour of the transmission-housing elements. This can advantageously protect the weld seam from mechanical influence from the outside, there in particular being no impairment of an outer housing surface due to a top bead of the weld seam. In embodiments, the weld seam is situated externally. Typically, the weld seam extends at least substantially perpendicularly to the axis of rotation of the planetary transmission. Typically, the weld seam has a radial extent which is greater than an axial extent of the weld seam. Typically, the weld seam is formed substantially in a manner running around the axis of rotation of the planetary transmission.

In typical embodiments, the joining regions comprise centering surfaces. The centering surfaces are typically arranged substantially parallel to the axis of rotation of the planetary transmission. Typically, the centering surfaces are arranged at least substantially perpendicularly to the respective stop surface or the respective connecting surface. Typically, the centering surfaces and the stop surfaces are in each case in contact at an edge of the surfaces. Typically, the centering surfaces and the connecting surfaces are in each case in contact at an edge of the surfaces. In other words, the centering surface is typically arranged between the stop surface and the connecting surface in each case. In embodiments, the centering surfaces have elevations, or noses. Typically, the centering surfaces, in particular for avoiding bypassing of current, may be formed so as to be insulating, for example by way of non-conductive coatings or an intermediate component.

Typically, the connecting surface of the first transmission-housing element and the connecting surface of the second transmission-housing element are welded to one another by means of resistance welding, in particular by means of capacitor discharge welding, and by way of example by means of a resistance projection welding connection. Resistance welding advantageously makes possible a welding connection with little energy expenditure, short process times and simple process control. Resistance welding methods advantageously allow welding of the connecting surfaces in the interior of the contour of the transmission-housing elements and in particular with avoidance of visible external weld beads. Resistance welding methods advantageously allow a simultaneous material bond across the connecting surface, in particular over the entire circumference, which reduces dimensional changes and changes in shape during the welding process.

Typically, at least one of the connecting surfaces of the first transmission-housing element or one of the connecting surfaces of the second transmission-housing element has, in particular before the welding process, welding projections. In particular, both the connecting surface of the first transmission-housing element and the connecting surface of the second transmission-housing element that is to be welded to the connecting surface of the first transmission-housing element have welding projections. Typically, at least one of the welding projections is formed in a manner running around the axis of rotation of the planetary transmission, in particular is of annular form. In typical embodiments, the width of the welding projection of the first connecting surface differs from the width of the welding projection of the second connecting surface. In particular, one of the welding projections is wider than the other welding projection at least by a factor 2, at least by a factor 3 or at least by a factor 4. By way of example, one of the welding projections has a width of 0.4 mm and another of the welding projections has a width of 1.4 mm.

In typical embodiments, the height of the welding projection of the first connecting surface differs from the height of the welding projection of the second connecting surface. In particular, a wider welding projection has a smaller height and vice versa. Typically, the height of one of the welding projections corresponds to at most 60% of the height of the other welding projection.

In other words, one of the connecting surfaces has ring projections and the other connecting surface has counterpart projections. This can advantageously ensure the required welding temperature at both connecting surfaces and ensure improved melting and reduced hardening or optimized notch geometry, and thus result in an improved welding connection with a greater load-bearing capacity. Typically, the planetary transmission, in particular in the region of the connecting surfaces, has clearances for receiving excess material.

In typical embodiments, the transmission-housing elements have electrode contact surfaces, in particular for electrical contacting of the housing elements. The electrode contact surfaces are typically connected in an electrically conductive manner to the connecting surfaces, and in particular to the welding projections. Typically, the electrode contact surfaces are arranged in a vicinity of the connecting surface. This can advantageously ensure short current paths between the electrode contact surface and the connecting surface and can increase the efficiency of the welding process. Typically, the electrode contact surfaces are designed in such a way that a high electrical conductivity is ensured.

Typically, the transmission-housing elements have force contact surfaces, in particular for accommodating a force acting axially on the transmission-housing elements during the welding process. In typical embodiments, the force contact surface is at the same time the electrode contact surface.

In typical embodiments, planar circular-ring segments on end faces of the transmission-housing elements are used as electrode contact surfaces and force contact surfaces. In embodiments, cylindrical outer surfaces of the transmission-housing elements are used as electrode contact surfaces and the end faces are used as force contact surfaces.

Typically, a first transmission-housing element of a planetary transmission and a second transmission-housing element of the planetary transmission are aligned with one another before a welding operation. In particular, the housing elements are aligned with one another in such a way that a first joining region of the first transmission-housing element and a second joining region of the second transmission-housing element engage one into the other. The alignment of the transmission-housing elements may comprise in particular an alignment in the radial direction. Typically, the centering surfaces of the transmission-housing elements, in particular as a fine-centering means without play, or alignment of the components by way of used tools or centering apparatuses, in particular as a pre-centering means with play, influences a deviation of the position of the transmission-housing elements before the welding operation.

Typically, the method for connecting the first transmission-housing element and the second transmission-housing element comprises contacting a first electrode contact surface of the first transmission-housing element with a first electrode and a second electrode contact surface of the second transmission-housing element with a second electrode. Typically, the first electrode and the second electrode are connected to an electrical energy supply. The electrical energy supply is suitable in particular for providing an electrical current which is suitable for at least partial fusion of the welding projections.

The method further comprises welding the first joining region of the first transmission-housing element to the second joining region of the second transmission-housing element. The welding comprises in particular introducing an electrical current into the connecting surface, and in particular into the welding projection, and applying a mechanical force to at least one of the transmission-housing elements.

Typically, the welding comprises applying a first mechanical force to a first force contact surface of the first transmission-housing element, and a second mechanical force to a second force contact surface of the second transmission-housing element. Typically, the force vector of the first mechanical force and the force vector of the second mechanical force are substantially parallel to the axis of rotation of the planetary transmission. Typically, the force vector of the first mechanical force and the force vector of the second mechanical force are substantially oppositely directed in relation to one another.

Typically, provision is made of at least one further housing element with a further joining region that is welded to the first joining region of the first transmission-housing element or to the second joining region of the second transmission-housing element or to a further joining region of a further transmission-housing element. The welding of the transmission-housing elements is typically carried out in steps, with two transmission-housing elements always being welded to one another. In alternative methods, the three or more transmission-housing elements are assembled and welded in one welding operation. This reduces the work steps and the manufacturing time.

The invention makes it possible to achieve a planetary transmission which is based on a modular, straightforward and clearly structured construction kit of transmission elements. The use of standardized joining regions, in particular with a standardized geometry, makes possible a large number of different transmission combinations from a small number of basic transmission elements, whereby, by way of example, scaling effects can be used. In this case, the transmission elements are not subjected to technological limitations with regard to production; in other words, the connection of the transmission elements is independent of the production method for the transmission elements, and in particular the transmission-housing elements.

Welding the connecting surfaces avoids preparation steps, for example cleaning or pre-treatment of the connecting surfaces, and allows a wide range of material pairings and a standardized method for connecting the transmission-housing elements, independent of the specific transmission elements of the planetary transmission.

### BRIEF DESCRIPTION OF THE DRAWINGS

The invention will be discussed in more detail below on the basis of the appended drawings, wherein, in the figures:

FIG. 1 shows a planetary transmission according to the invention in a longitudinal section;

FIG. 2 shows a detail in FIG. 1;

FIG. 3a shows a planetary transmission according to the invention in a longitudinal section;

FIG. 3b shows a planetary transmission according to the invention in a longitudinal section;

### DETAILED DESCRIPTION

Typical exemplary embodiments will be described below on the basis of the figures, with the invention not being limited to the exemplary embodiments; rather, the scope of the invention is defined by the claims. In the description of the embodiments, in some cases, the same reference signs are used for identical or similar parts in different figures and for different embodiments in order to make the description clearer. However, this does not mean that corresponding parts of the invention are limited to the variants illustrated in the embodiments. For the sake of clarity, features which have already been described in conjunction with other figures will sometimes not be described again. Features which are illustrated multiple times in a figure are sometimes denoted by a reference sign only once.

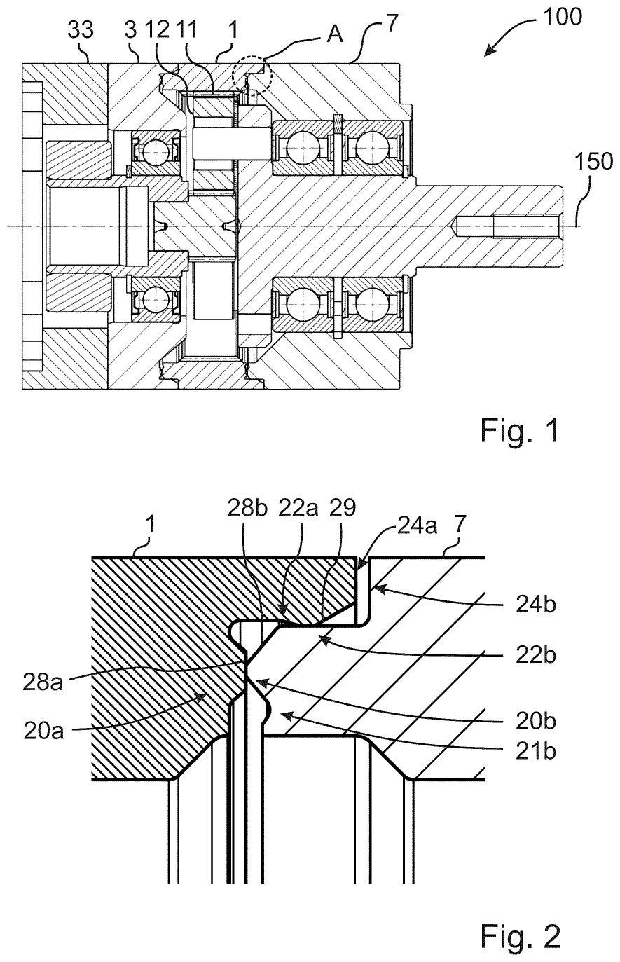

FIG. 1 shows a planetary transmission 100 according to the invention with transmission-housing elements 1, 5, 7. The planetary transmission 100 has a transmission-housing element 1 with an internal toothing 11 which is oriented toward an axis of rotation 150 of the planetary transmission 100. The planetary transmission 100 shown in FIG. 1 is of single-stage design and has exactly one transmission-housing element 1 with an internal toothing 11 which is oriented toward an axis of rotation 150 of the planetary transmission 100. The internal toothing 11 engages with planet gears 12 of the planetary transmission 100. The transmission-housing element 1 with the internal toothing 11 oriented toward an axis of rotation 150 of the planetary transmission 100 is connected to a drive flange 3. In particular, the drive flange 3 is welded to the transmission-housing element 1. The transmission-housing element 1 with the internal toothing 11 oriented toward an axis of rotation 150 of the planetary transmission 100 is connected to a bearing flange 7. In particular, the bearing flange 7 is welded to the transmission-housing element 1. The transmission-housing element 1 has two joining regions. The joining region which engages into the joining region of the bearing flange 7 is marked with the designation A and is illustrated in detail in FIG. 2, wherein FIG. 2 illustrates an arrangement before the welding process. The joining regions are of substantially stepped form.

FIG. 2 shows the detail A in FIG. 1 before the welding of the transmission-housing element 1 to the bearing flange 7. The transmission-housing element 1 has a stepped or S-shaped joining region. The joining region of the transmission-housing element 1 comprises a connecting surface 20a which is formed in a running-around manner and which is substantially perpendicular to the axis of rotation. The connecting surface 20a has a welding projection 28a. The welding projection 28a is arranged approximately centrally in a radial direction on the connecting surface 20a. The joining region of the transmission-housing element 1 further comprises a stop surface 24a which is arranged radially outside the connecting surface 20a in relation to the axis of rotation. The stop surface 24a and the connecting surface 20a are arranged in a substantially parallel manner, in particular in terms of their geometrical basic shape. The joining region of the transmission-housing element 1 further comprises a centering surface 22a. The centering surface 22a is arranged substantially parallel to the axis of rotation of the planetary transmission and at least substantially perpendicularly to the stop surface 24a and to the connecting surface 20a. The centering surface 22a has an elevation 29, in particular for centering the transmission-housing element 1.

The bearing flange 7 likewise has a stepped or S-shaped joining region. In terms of geometrical basic shape, the joining region of the bearing flange 7 is formed oppositely in relation to the joining region of the transmission-housing element 1. In particular, the joining region of the bearing flange 7 and the joining region of the transmission-housing element 1 engage one into the other. The joining region of the bearing flange 7 has a connecting surface 20b. The connecting surface 20b is arranged, in the installed state and after positioning in preparation for the welding process, substantially parallel to the connecting surface 20a of the transmission-housing element 1. The connecting surface 20b of the bearing flange has a welding projection 28b. The connecting surfaces 20a, 20b are arranged substantially opposite one another. In FIG. 2, the welding projection 28b is higher than the welding projection 28a, which however has a wider plateau at the tip of the welding projection 28a. The connecting surface 20b has a recess 21b which is arranged in particular closer to the axis of rotation than the welding projection 28b and which serves for receiving material during the welding process. The joining region of the bearing flange 7 further has a centering surface 22b. The centering surface 22b is substantially parallel to the axis of rotation of the planetary transmission and at least substantially perpendicular to a stop surface 24b and to the connecting surface 20b. A further receptacle for welding material is arranged in the transition from the connecting surfaces 20a, 20b to the centering surfaces 22a, 22b. The joining region of the bearing flange 7 further has the stop surface 24b. The stop surface 24b is arranged radially outside the connecting surface 20b in relation to the axis of rotation. The stop surface 24b and the connecting surface 20b are arranged in a substantially parallel manner, in particular in terms of their geometrical basic shape. The stop surface 24b is arranged substantially parallel to the stop surface 24a of the transmission-housing element 1. The details illustrated in FIG. 2 of the joining regions can be applied to all the joining regions shown in the further figures. In particular, typically all the joining regions of the planetary transmission are of identical construction, so as to advantageously allow modularity of the planetary transmission.

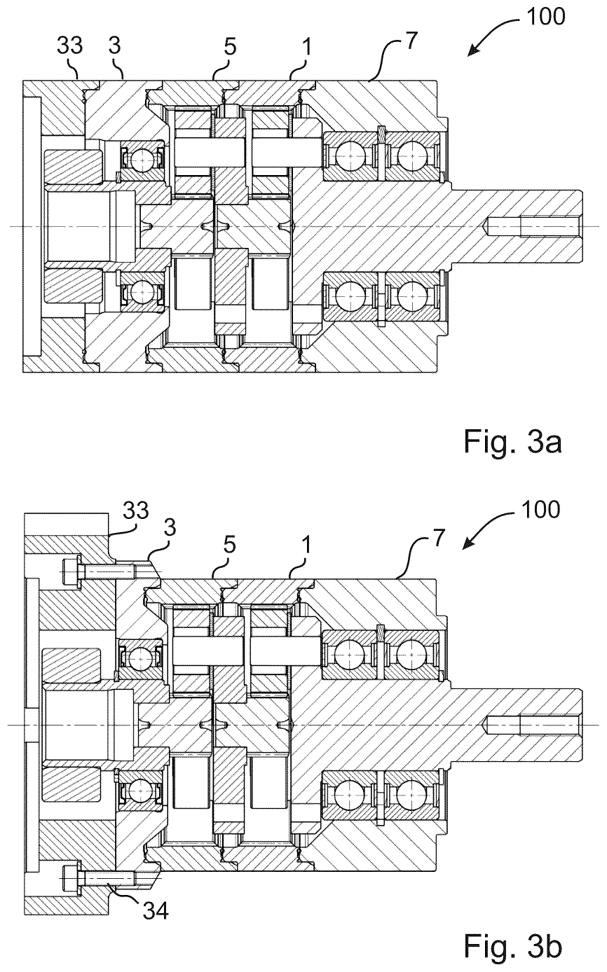

FIGS. 3a and 3b illustrate two-stage planetary transmissions 100. In particular, the planetary transmissions 100 comprise two transmission-housing elements 1, 5 with in each case one internal toothing which is oriented toward the axis of rotation of the planetary transmission. The two transmission-housing elements 1, 5 with internal toothing are connected via joining regions, as shown in FIG. 2. In FIG. 3a, the planetary transmission 100 has an adapter plate 33 which is welded to the drive flange 3. In particular, the adapter plate 33 has a joining region as illustrated in FIG. 2. The adapter plate 33 is thus part of the modular system of the planetary transmission 100. The drive flange 3 has two joining regions, analogously to the joining region illustrated in FIG. 2.

In FIG. 3b, the planetary transmission 100 has an adapter plate 33 which is screwed to the drive flange 3. In particular, the drive flange 3 has receptacles for receiving fastening screws 34.

1. Planetary transmission (100) having transmission-housing elements (1, 3, 5, 7), wherein
at least one (1) of the transmission-housing elements has an internal toothing (11) which is oriented toward an axis of rotation (150) of the planetary transmission,
the transmission-housing elements have in each case at least one joining region,
the at least one joining region having in each case one connecting surface (20a, 20b), which is oriented at least substantially perpendicularly to the axis of rotation and in a manner running around the axis of rotation, and one stop surface (24a, 24b), which is spaced apart axially from the connecting surface and is oriented at least substantially perpendicularly to the axis of rotation and in a manner running around the axis of rotation, and wherein
the connecting surface of the first transmission-housing element is welded to the connecting surface of the second transmission-housing element.

2. Planetary transmission according to claim 1, wherein the connecting surface of the first transmission-housing element and the connecting surface of the second transmission-housing element are welded to one another by means of a resistance projection welding connection.

3. Planetary transmission according to claim 2, wherein the resistance projection welding connection is produced by means of welding projections (28a, 28b) which are arranged on the connecting surface of the first transmission-housing element and on the connecting surface of the second transmission-housing element.

4. Planetary transmission according to claim 1, wherein the stop surfaces abut against one another.

5. Planetary transmission according to claim 1, wherein the welded connecting surfaces are arranged radially further to the inside in relation to the respective stop surfaces of the respective joining regions.

6. Planetary transmission according to claim 1, wherein at least three transmission-housing elements are provided.

7. Planetary transmission according to claim 1, wherein the at least one transmission-housing element with the internal toothing has two joining regions.

8. Planetary transmission according to claim 1, wherein the at least one joining region comprises in each case one centering surface (22a, 22b) arranged substantially parallel to the axis of rotation.

9. Planetary transmission according to claim 1, wherein a weld seam for connecting the first connecting surface to the second connecting surface extends at least substantially perpendicularly to an axis of rotation of the planetary transmission.

10. Planetary transmission according to claim 1, wherein the transmission-housing elements comprise a drive flange (3), a bearing flange (7) and/or an adapter plate (33).

11. Method for connecting a first transmission-housing element of a planetary transmission and a second transmission-housing element of the planetary transmission, wherein the first transmission-housing element has an internal toothing oriented toward an axis of rotation of the planetary transmission and has a first joining region, and the second transmission-housing element has a second joining region, wherein the joining regions are of stepped form, and wherein the first joining region and/or the second joining region have welding projections, the method comprising:
aligning the first transmission-housing element and the second transmission-housing element with one another so that the first joining region and the second joining region engage one into the other; and
welding the first joining region of the first transmission-housing element to the second joining region of the second transmission-housing element by means of a resistance welding process.

12. Method according to claim 11, wherein
the first joining region and the second joining region have in each case one connecting surface and one axially spaced-apart stop surface,
the connecting surface and the stop surface are arranged in each case at least substantially perpendicularly to the axis of rotation of the planetary transmission;
the connecting surface of the first joining region of the first transmission-housing element and the connecting surface of the second joining region of the second transmission-housing element are welded to one another;
and the stop surface of the first transmission-housing element and the stop surface of the second transmission-housing element abut against one another.

13. Method according to claim 11, wherein at least one of the welding projections is formed in a manner running around the axis of rotation of the planetary transmission.

14. Method according to claim 11, further comprising contacting a first electrode contact surface of the first transmission-housing element with a first electrode and a second electrode contact surface of the second transmission-housing element with a second electrode.

15. Planetary transmission having a first transmission-housing element and a second transmission-housing element which are connected using a method according to claim 11.
